(19) United States
(12) Patent Application Publication
(10) Pub. No.: US 2005/0256923 A1
(43) Pub. Date: Nov. 17, 2005

(54) METHODS AND APPARATUS FOR DISPLAYING APPLICATION OUTPUT ON DEVICES HAVING CONSTRAINED SYSTEM RESOURCES

(75) Inventor: Tetsunori ADACHI, Tokyo (JP)

Correspondence Address: LAHIVE & COCKFIELD, LLP., 28 STATE STREET, BOSTON, MA, 02109, US

(73) Assignee: CITRIX SYSTEMS, INC., Fort Lauderdale, FL (US)

(21) Appl. No.: 10/709,581

(22) Filed: May 14, 2004

(51) Int. Cl. G06F 15/16

(52) U.S. Cl. 709/203

(57) ABSTRACT

A system for displaying at a user device output produced by an application program executing on a server includes an application server executing an application program. A proxy server receives data from the application server that represents a screen of graphical display output produced by the application program. A user device executes a client application. The client application receives from the proxy server static image data representing the screen of graphical display output produced by the application program.

### FIELD OF THE INVENTION

The present invention relates generally to displaying at client devices the output of application programs executing on server devices and, more particularly, to techniques and apparatus for displaying the output of application programs on devices having constrained system resources.

### BACKGROUND OF THE INVENTION

Technologies for providing remote access to networked resources include a variety of client/server software combinations. One of these combinations is often referred to as a “thin-client” or a “distributed application processing” system. In these systems, an application program is executed by a server computing device, usually referred to as the “application server,” on behalf of one or more client computing devices, usually referred to as the “thin-client” or the “thin-client application.” Only input to the application received from the user at the thin-client and output produced by an application executing on the application server are transmitted between the thin-client and the application server. Thin-client computing architectures are popular implementations for providing remote connectivity to applications and other system resources. Examples of such systems include: Citrix MetaFrame Presentation Server software in combination with Intelligent Computing Architecture (ICA) clients, available from Citrix Systems, Inc. of Fort Lauderdale, Fla.; X servers in combination with X Windows clients available from the X Consortium; and Microsoft Windows NT Server 4.0 Terminal Server Edition in combination with Remote Display Protocol (RDP) clients, available from Microsoft Corporation of Redmond, Wash.

Because a client in a thin-client computing architecture does not execute the application program and is required to transmit only user input to the application server and display only output of the application executing on the application server, the client device may offer limited amounts of memory, slower communication subsystems, and limited system resources without degradation in performance that is noticeable to the user. A personal computer, workstation, or other similar computing device typically provides ample system resources to execute the thin-client application and communicate with the application server.

However, more users requiring remote connectivity are using computing devices as thin-clients that do not provide sufficient memory, network resources, or proper operating system environments to function as thin-clients, such as cell phones and personal digital assistants. For example, many current cell phones provide less than 1 Megabyte of random access memory, which is generally not sufficient for execution of the thin-client application. Further, it is often useful for an embedded system to access an application server for application output. Typically, these systems are also limited in resources such as memory.

It would be useful to have a system allowing client devices having constrained system resources, such as limited memory, to interact with application programs executing on application servers.

### BRIEF SUMMARY OF THE INVENTION

The present invention enables low-end client devices, such as cell phones, personal digital assistants, and embedded systems, to interact with application programs executing on application servers, allowing applications to accessed remotely from various locations.

In one aspect the present invention relates to a system for displaying at a user device output produced by an application program executing on a server. The system includes an application server executing an application program. A proxy server receives data from the application server, the data representing a screen of graphical display output produced by the application program. A user device executes a client application that receives static image data from the proxy server. The received static image data represents the screen of graphical display output produced by the application program.

In another aspect the present invention relates to a method for displaying at a user device output produced by an application program executing on a server. An application server executes an application producing a screen of graphical user interface data and transmits to a proxy server the screen of produced graphical user interface data. The proxy server transmits to a user device static image data representing at least a portion of the screen of produced graphical user interface data. The user device displays the transmitted static image data.

In still another aspect the present invention relates to an apparatus for displaying at a user device output produced by an application program executing on a server. The apparatus includes a first protocol handler receiving from an application server data in a first protocol format, the data representative of a screen of graphical display output produced by an application executing on the application server. The apparatus also includes a second protocol handler transmitting to a client application for display static image data in a second protocol format, the static image data representative of at least a portion of the screen of graphical display output received by the first protocol handler.

In yet another aspect the present invention relates to a method for displaying at a user device graphical display output produced by an application program executing on a server. Static image data is received from an application server, via a first protocol, representative of a screen of graphical display output produced by an application executing on the application server. The static image data is transmitted to a client application for display via a second protocol, the static image data representative of at least a portion of the screen of graphical display output produced by the application executing on the application server.

In still yet another aspect the present invention relates to a system for displaying at a user device output produced by an application program executing on a server. The system includes an application server executing an application program. The system also includes a proxy server receiving from the application server data that represents a screen of graphical display output produced by the application program via a presentation-level protocol. The system further includes a user device executing a client application, the client application receiving from said proxy server static image data representing the screen of graphical display output produced by the application program via HyperText Transfer Protocol (HTTP) commands.

In another aspect the present invention relates to a method for displaying at a user device output produced by an application program executing on a server. An application server executes an application that produces a screen of graphical user interface data. The application server transmits to a proxy server, via a presentation-level protocol, the screen of produced graphical user interface data. The proxy server transmits to a user device, via HyperText Transfer Protocol (HTTP) commands, static image data representing at least a portion of the screen of produced graphical user interface data. The user device displays the transmitted static image data.

In still another aspect, the present invention relates to an article of manufacture having embodied thereon computer-readable program means for displaying at a user device output produced by an application program executing on a server. The article of manufacture includes: computer-readable program means for transmitting to a proxy server a screen of graphical user interface data produced by an application executing on the server; computer-readable program means for communicating to a user device, by the proxy server, static image data representing at least a portion of the screen of produced graphical user interface data; and computer-readable program means for displaying, by the user device, the transmitted static image data.

In a still further aspect the present invention relates to an article of manufacture having embodied thereon computer-readable programs means for displaying at a user device graphical display output produced by an application program executing on a server. The article of manufacture includes: computer-readable program means for receiving from an application server, via a first protocol, data representative of a screen of graphical display output produced by an application executing on the application server; and computer-readable programs means for transmitting to a client application for display, via a second protocol, static image data representative of at least a portion of the screen of graphical display output produced by the application executing on the application server.

### BRIEF DESCRIPTION OF THE DRAWINGS

These and other aspects of this invention will be readily apparent from the detailed description below and the appended drawings, which are meant to illustrate and not to limit the invention, and in which:

FIG. 1 is a block diagram of one embodiment of a system for providing application output to devices having constrained system resources;

FIGS. 2A and 2B are block diagrams depicting embodiments of computers useful in connection with the present invention;

FIG. 3 is a flowchart depicting one embodiment of the operation of a system for providing application output to devices having constrained system resources;

FIG. 4 is a diagrammatic representation of one embodiment of a protocol used to communicate application output to devices having constrained systems resources.

### DETAILED DESCRIPTION OF THE INVENTION

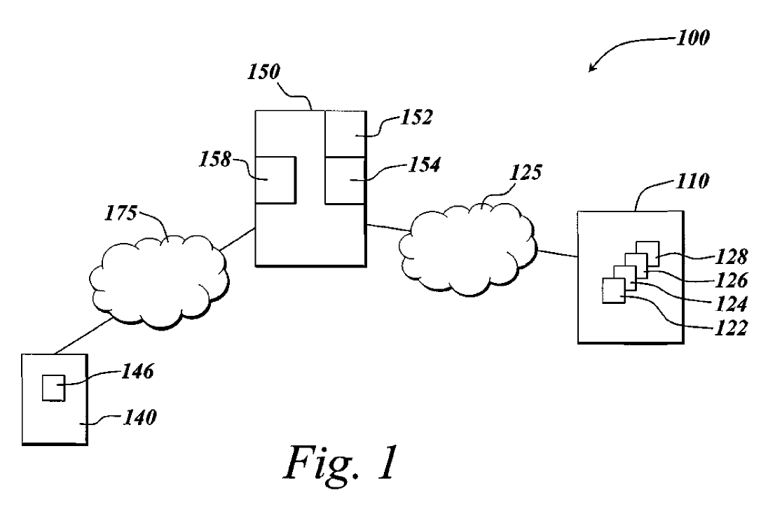

Referring now to FIG. 1, a system 100 for providing application output to a client device having constrained system resources includes an application server 110, a proxy server 150, and a client 140. Although only one application server 110, proxy server 150, and client 140 is depicted in the embodiment shown in FIG. 1, it should be understood that the system may provide multiple ones of any or each of those components. For example, in one embodiment, the system 100 includes multiple, logically-grouped application servers 110, each of which are available to execute applications on behalf of a client 140. In these embodiments, the logical group of servers may be referred to as a “server farm.” In other embodiments, multiple proxy servers 150 may be provided. In some of these embodiments, the proxy servers may be geographically dispersed.

The application server 110 executes one or more application programs 122, 124, 126, 128 on behalf of a client 140. An application program is any program that processes data to provide output and that uses an operating system for access to system resources. Exemplary application programs include: word processing applications, such as MICROSOFT WORD, manufactured by Microsoft Corporation of Redmond, Wash.; spreadsheet programs, such as MICROSOFT EXCEL, manufactured by Microsoft Corporation; electronic mail programs, such as MICROSOFT OUTLOOK, manufactured by Microsoft Corporation and GROUPWISE, manufactured by Novell Corp. of Provo, Utah; and productivity suites such as STAR OFFICE, manufactured by Sun Microsystems of Mountain View, Calif.

The application server 110 communicates with the proxy server 150 over a first network 125. The first network 125 can be a local area network (LAN), a metropolitan area network (MAN), or a wide area network (WAN) such as the Internet. The application server 110 and the proxy server 150 may connect to the first network 125 through a variety of connections including standard telephone lines, LAN or WAN links (e.g., T1, T3, 56 kb, X.25), broadband connections (ISDN, Frame Relay, ATM), and wireless connections. Connections between the application server 110 and the proxy server 150 may use a variety of data-link layer communication protocols (e.g., TCP/IP, IPX, SPX, NetBIOS, NetBEUI, SMB, Ethernet, ARCNET, Fiber Distributed Data Interface (FDDI), RS232, IEEE 802.11, IEEE 802.11a, IEE 802.11b, IEEE 802.11g and direct asynchronous connections).

The proxy server 150 executes one or more thin-client applications 152, 154 such as a Remote Display Protocol client, manufactured by Microsoft Corporation or an ICA client, manufactured by Citrix Systems, Inc. of Fort Lauderdale, Fla. The application server 110 communicates the output of the application programs 122, 124, 126, 128 to thin-client applications 152, 154 executing on the proxy server 150 and receives user input directed to the application programs 122, 124, 126, 128 from the thin-client application 152, 154. The application server 110 communicates with the thin-client applications 152, 154 over network 125 using a presentation-layer protocol such as the Independent Computing Architecture (ICA) protocol, available from Citrix Systems, Inc. of Fort Lauderdale, Fla. or the Remote Display Protocol (RDP), available from Microsoft Corporation. Although only two thin-client applications are depicted in the embodiment shown in FIG. 1, the proxy server 150 may host any number of thin-client applications 152, 154.

The proxy server 150 also executes a proxy server application 158. The proxy server application 158 may be an application program, a subsystem or a service. The proxy server application 158 manages the thin-client applications 152, 154 hosted by the proxy server 150. The proxy server application also transmits application output received by the thin-client applications 152, 154 to the client device 140 and transmits user input received from the client device 140 to the appropriate thin-client application 152, 154 executing on the proxy server 150.

The proxy server application 158 executing on the proxy server 150 communicates with the client 140 over a second network 175. For embodiments in which the client 140 is an embedded system, the client 140 and the proxy server 150 may connect to the second network 175 through a variety of connections including standard telephone lines, LAN or WAN links (e.g., T1, T3, 56 kb, X.25), broadband connections (ISDN, Frame Relay, ATM), and wireless connections. Connections between the client 140 and the proxy server 150 may use a variety of data-link layer communication protocols (e.g., TCP/IP, IPX, SPX, NetBIOS, NetBEUI, SMB, Ethernet, ARCNET, Fiber Distributed Data Interface (FDDI), RS232, IEEE 802.11, IEEE 802.11a, IEE 802.11b, IEEE 802.11g and direct asynchronous connections).

In other embodiments, the client device 140 is a mobile device, such as a cellular telephone or a personal digital assistant. In these embodiments, the client 140 and the proxy server application 158 connect to the second network using any one of a number of well-known protocols from the GSM or CDMA families, such as W-CDMA. These protocols support commercial wireless communication services and W-CDMA, in particular, is the underlying protocol supporting i-Mode and mMode services, offered by NTT DoCoMo.

The client device 140 executes a client application 146. The client application transmits and receives http or https requests to and from the proxy server application 158. The client application 148 transmits user input directed to an executing application program 122, 124, 126, 128 to the proxy server application 158 over the second network 175. It is also responsible for rendering graphical output on the screen of the client device corresponding to the output of the application program 122, 124, 126, 128 executing on the application server 110.

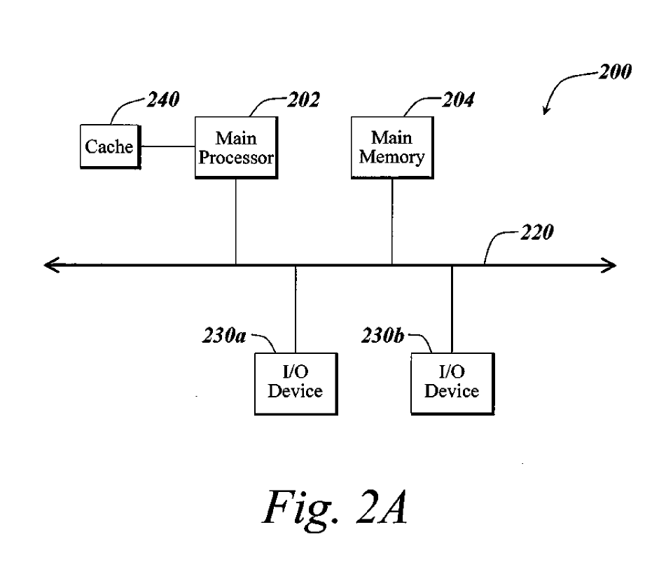

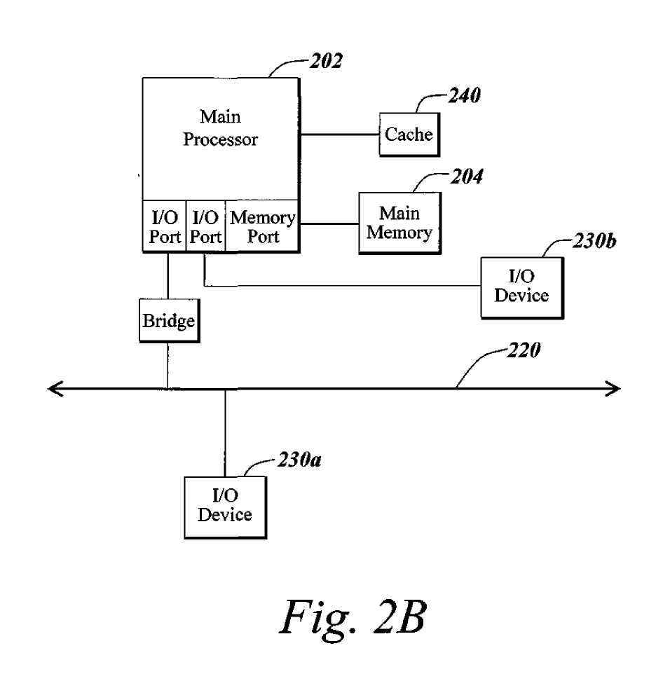

In many embodiments, the application server 110 and the proxy server 150 are provided as personal computer or computer servers, of the sort manufactured by the Hewlett-Packard Corporation of Palo Alto, Calif. or the Dell Corporation of Round Rock, Tex. For embodiments in which the client device 140 is an embedded system, the client device 140 may also be provided as a personal computer. FIGS. 2A and 2B depict block diagrams of a typical computer 200 useful as the application server 110, the proxy server 150, or the client device in those embodiments. As shown in FIGS. 2A and 2B, each computer 200 includes a central processing unit 202, and a main memory unit 204. Each computer 200 may also include other optional elements, such as one or more input/output devices 230a-230n (generally referred to using reference numeral 230), and a cache memory 240 in communication with the central processing unit 202.

The central processing unit 202 is any logic circuitry that responds to and processes instructions fetched from the main memory unit 204. In many embodiments, the central processing unit is provided by a microprocessor unit, such as: the 8088, the 80286, the 80386, the 80486, the Pentium, Pentium Pro, the Pentium II, the Celeron, or the Xeon processor, all of which are manufactured by Intel Corporation of Mountain View, Calif.; the 68000, the 68010, the 68020, the 68030, the 68040, the PowerPC 601, the PowerPC604, the PowerPC604e, the MPC603e, the MPC603ei, the MPC603ev, the MPC603r, the MPC603p, the MPC740, the MPC745, the MPC750, the MPC755, the MPC7400, the MPC7410, the MPC7441, the MPC7445, the MPC7447, the MPC7450, the MPC7451, the MPC7455, the MPC7457 processor, all of which are manufactured by Motorola Corporation of Schaumburg, Ill.; the Crusoe TM5800, the Crusoe TM5600, the Crusoe TM5500, the Crusoe TM5400, the Efficeon TM8600, the Efficeon TM8300, or the Efficeon TM8620 processor, manufactured by Transmeta Corporation of Santa Clara, Calif.; the RS/6000 processor, the RS64, the RS 64 II, the P2SC, the POWER3, the RS64 III, the POWER3-II, the RS 64 IV, the POWER4, the POWER4+, the POWER5, or the POWER6 processor, all of which are manufactured by International Business Machines of White Plains, N.Y.; or the AMD Opteron, the AMD Athalon 64 FX, the AMD Athalon, or the AMD Duron processor, manufactured by Advanced Micro Devices of Sunnyvale, Calif.

Main memory unit 204 may be one or more memory chips capable of storing data and allowing any storage location to be directly accessed by the microprocessor 202, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM).

In the embodiment shown in FIG. 2A, the processor 202 communicates with main memory 204 via a system bus 220 (described in more detail below). FIG. 2B depicts an embodiment of a computer system 200 in which the processor communicates directly with main memory 204 via a memory port. For example, in FIG. 2B the main memory 204 may be DRDRAM.

FIGS. 2A and 2B depict embodiments in which the main processor 202 communicates directly with cache memory 240 via a secondary bus, sometimes referred to as a “backside” bus. In other embodiments, the main processor 202 communicates with cache memory 240 using the system bus 220. Cache memory 240 typically has a faster response time than main memory 204 and is typically provided by SRAM, BSRAM, or EDRAM.

In the embodiment shown in FIG. 2A, the processor 202 communicates with various I/O devices 230 via a local system bus 220. Various busses may be used to connect the central processing unit 202 to the I/O devices 230, including a VESA VL bus, an ISA bus, an EISA bus, a MichroChannel Architecture (MCA) bus, a PCI bus, a PCI-X bus, a PCI-Express bus, or a NuBus. For embodiments in which the I/O device is an video display, the processor 202 may use an Advanced Graphics Port (AGP) to communicate with the display. FIG. 2B depicts an embodiment of a computer system 200 in which the main processor 202 communicates directly with I/O device 230b via HyperTransport, Rapid I/O, or InfiniBand. FIG. 2B also depicts an embodiment in which local busses and direct communication are mixed: the processor 202 communicates with I/O device 230a using a local interconnect bus while communicating with I/O device 230b directly.

A wide variety of I/O devices 230 may be present in the computer system 200. Input devices include keyboards, mice, trackpads, trackballs, microphones, and drawing tablets. Output devices include video displays, speakers, inkjet printers, laser printers, and dye-sublimation printers. An I/O device may also provide mass storage for the computer system 200 such as a hard disk drive, a floppy disk drive for receiving floppy disks such as 3.5-inch, 5.25-inch disks or ZIP disks, a CD-ROM drive, a CD-R/RW drive, a DVD-ROM drive, tape drives of various formats, and USB storage devices such as the USB Flash Drive line of devices manufactured by Twintech Industry, Inc. of Los Alamitos, Calif.

In further embodiments, an I/O device 230 may be a bridge between the system bus 220 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

General-purpose desktop computers of the sort depicted in FIGS. 2A and 2B typically operate under the control of operating systems, which control scheduling of tasks and access to system resources. Typical operating systems include: MICROSOFT WINDOWS, manufactured by Microsoft Corp. of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, among others.

For embodiments in which the client device 140 is a mobile device, the client device may be a JAVA-enabled cellular telephone, such as the i50sx, i55sr, i58sr, i85s i88s, i90c, i95cl, or the im11000, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea. In other embodiments in which the client device 140 is mobile, it may be a personal digital assistant (PDA) operating under control of the PalmOS operating system, such as the Tungsten W, the VII, the VIIx, the i705, all of which are manufactured by palmOne, Inc. of Milpitas, California. In further embodiments, the client device 140 may be a personal digital assistant (PDA) operating under control of the PocketPC operating system, such as the iPAQ 4155, iPAQ 5555, iPAQ 1945, iPAQ 2215, and iPAQ 4255, all of which manufactured by Hewlett-Packard Corporation of Palo Alto, Calif., the ViewSonic V36, manufactured by ViewSonic of Walnut, California, or the Toshiba PocketPC e405, manufactured by Toshiba America, Inc. of New York, N.Y. In still other embodiments the client device is a combination PDA/telephone device such as the Treo 180, Treo 270 or Treo 600, all of which are manufactured by palmOne, Inc. of Milpitas, Calif. In still further embodiment, the client device 140 is a cellular telephone that operates under control of the PocketPC operating system, such as the MPx200, manufactured by Motorola Corp.

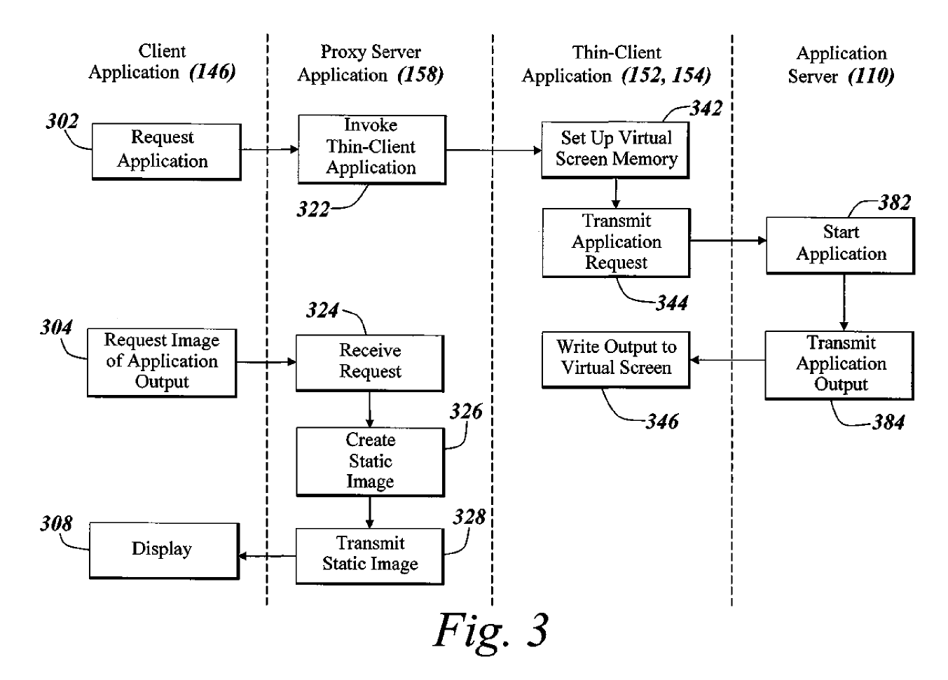

FIG. 3 depicts the operation of the system just described in FIGS. 1-2B. The client application 146 transmits to the proxy server application 158 a request to have an application program 122, 124, 126, 128 executed on its behalf (step 302). In some embodiments, the http request transmitted by the client application 146 includes the name of the application the user wants to have executed. In other embodiments, the request may identify a file on which the user wants to work. In these embodiments, the request includes the file type and the proxy server application 158 identifies one or more application programs capable of processing the file. For example, the proxy server application 158 may look up the application program to use from a table mapping file types to specific application programs associated with those files types. In still further embodiments, the http request transmitted by the client application 146 may specifically identify a particular published desktop or particular server 100 on which the application program 122, 124, 126, 128 should be executed.

The proxy server application 158 spawns a thin client application 152, 154 (step 322) and provides the thin-client application 152, 154 with the identity of the requested program. The thin-client application 152, 154 operates in a manner well-known in the art, except that the thin-client application 152, 154 sets aside a block of memory to which the thin-client writes application output (step 342). Put another way, the thin-client application 152, 154 writes application output to a virtual screen maintained in memory rather than to a visual display, as is usually done in the art. In some embodiments, however, the thin-client application 152, 154 writes to both a virtual screen and to a traditional display screen.

The thin-client application 152, 154 transmits a request to a server 110 to begin execution of an application program 122, 124, 126, 128 (step 344). In some embodiments the thin-client application 152, 154 transmits the request to one server in a server farm, which responds to the thin-client application 152, 154 with the address of a server 110 hosting the requested application program 122, 124, 126, 128. In other embodiments, the thin-client application 152, 154 transmits the request to a service access point, which returns a document to the client device 140 that provides the client application 146 with the necessary information to connect to the appropriate application server 110. In all of these embodiments, the thin-client application 152, 154 initiates a connection with the identified server 110.

In other embodiments, the thin-client application 152, 154 sets up a virtual screen memory area (step 342) after transmitting the application request to the application server 110 (step 344). In still other embodiments, these actions happen substantially simultaneously.

The server 110 begins executing the requested application program 122, 124, 126, 128 (step 382) and transmits graphical application output over the first network 125 using a thin-client presentation protocol (step 384). Various embodiments of the steps taken by the application server 110 to form presentation-level protocol packets for transmission to the thin-client application 152, 154 are described in U.S. Pat. Nos. 6,141,737, 6,118,899, 6,081,623, 6,057,857 and 6,016,535, the entire contents of which are incorporated herein by reference.

The thin-client application 152, 154 decodes presentation protocol packets received from the application server 110 and writes graphical application output represented by the presentation protocol packets to the virtual screen memory (step 346). In many embodiments, the virtual screen memory is a screen buffer, i.e., the virtual screen memory area stores a bitmap representation of data required to form a visual display of the graphical output.

In the embodiment shown in FIG. 3, the client application 146 transmits a request for a static image representing the current state of the graphical application output to the proxy server application (step 304). The client application may request the current state of the graphical application output every minute, every thirty seconds, every 15 seconds, every 10 seconds, every 5 seconds, every other second, once a second, twice a second, five times a second, ten times a second, twenty times a second, or thirty times a second. In other embodiments, the proxy server application 158 periodically transmits a static image representing the current state of the graphical application output to the client application 146. In these other embodiments, the proxy server application 158 may transmit updates to the client application 146 every minute, every thirty seconds, every 15 seconds, every 10 seconds, every 5 seconds, every other second, once a second, twice a second, five times a second, ten times a second, twenty times a second, or thirty times a second. Alternatively, the proxy server application 158 may transmit an update to the client application 146 when the proxy server application 158 determines that a predetermined percentage of the virtual screen memory area has changed state or whenever a request for the current state of the graphical application output is received by the proxy server application.

Referring back to FIG. 3, the proxy server application 158 receives the transmitted request (step 324) and creates a static image file using the virtual screen memory of the appropriate thin-client application 152, 154 as input (step 326). In some embodiments, the client application 146 stores the state of its connection with the proxy server application 158, for example, in a “cookie.” In these embodiments, the transmitted request (step 324) may include a session identifier that the proxy server application 158 uses to select from which virtual screen memory to create the static image file. In further of these embodiments, the request includes a unique identifier associated with the client device 140. For example, for embodiments in which the client device 140 is a cell phone, the unique identifier may be the telephone number associated with the cell phone.

In other embodiments, the client application 146 does not store the state of its connection with the proxy server application 158. In these embodiments, the session must be identified in the transmitted request (step 324) in a manner that does not reveal the session identifier to an eavesdropper. For example, the portion of the transmitted http request (step 324) that identifies the session may be encrypted using a private key shared between the client application 146 and the proxy server application 158. In further of these embodiments, the request includes a unique identifier associated with the client device 140, which may also be encrypted to protect it from an eavesdropper. For example, for embodiments in which the client device 140 is a cell phone, the unique identifier may be the telephone number associated with the cell phone.

The static image created by the proxy server application 158 may be in any one of a number of standard formats, including JPEG, GIF, PNG, TIFF, or BMP. In some embodiments, the proxy server application 158 calls a Common Object Model (COM) Application Programming Interface (API) exposed by the thin-client application 152, 154 to create the static image.

In some embodiments, the proxy server application 158 optimizes the size of the static image created. In one of these embodiments, the proxy server application 158 determines the size of the screen image by selecting the screen area surrounding the user's current position. The user's current position may determined by using the x coordinate and y coordinate of the last mouse click or the x coordinate and y coordinate of the last mouse position to be transmitted to the proxy server application 158. The amount of the screen above, below, to the left of and to the right of the user's last position that is used to create the screen image may be set to a predetermined number of pixels, or it may be selected based on the client device 140.

In another embodiment, the proxy server application 158 increases the amount of image loss that is acceptable. That is, the proxy server application 158 uses a lossy compression algorithm, such as JPEG, to encode the screen image before transmission. The proxy server application 158 may select the amount of image loss that is acceptable based on the image type to be transmitted, the relative size differential between the screen of the client device 158 and the virtual screen memory, the absolute size of the screen of the client device 140, the bit depth of the screen of the client device 140, or the bandwidth available for use over the network 175.

In still other embodiments, the proxy server application 158 does not use a static image to transmit screens that have no graphical elements. In these embodiments, the client application 146 exposes a separate set of programming interfaces for text drawings commands and for graphical commands. For screens having no graphical elements, only text drawing calls would be made to render the application output screen.

In still other embodiments, the proxy server application 158 scales the application output read from the virtual screen buffer so that the screen, or a larger portion of the screen, is viewable on the screen of the client device 140. Alternatively, the scaling may be provided by a COM interface.

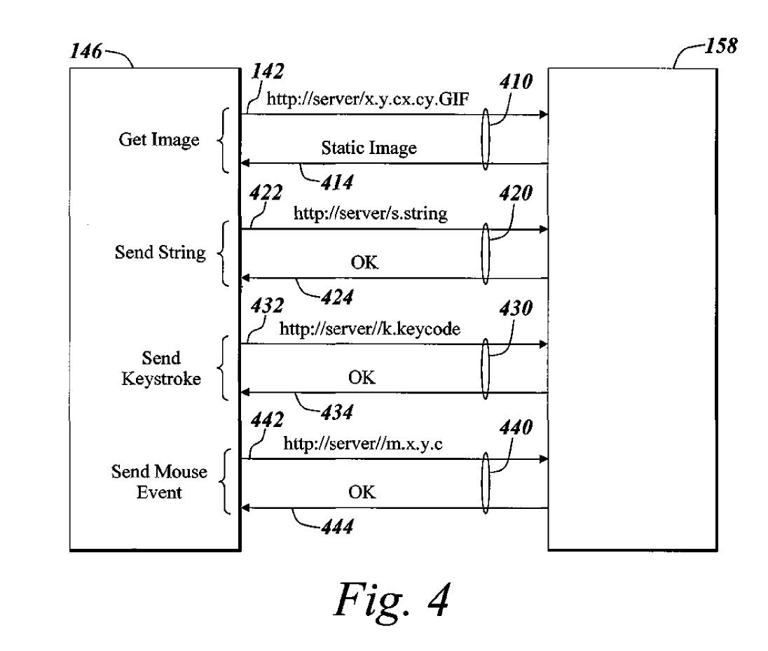

The proxy server application 158 transmits the created static image file to the client application 146 (step 328). In some embodiments, a single session identifier may be shared between multiple client devices 140, allowing one or more client devices 140 to shadow another client device 140, i.e. the output displayed by the “shadowing” client devices 140 is the same as the “shadowed” client device 140. In one embodiment, the static image file is transmitted to client application 146 using HyperText Transfer Protocol (http) or Secure HyperText Transfer Protocol (https). The protocol used to transmit static image files to the client application 146 and to receive client input from the client application 146 is described in more detail in connection with FIG. 4 below. The client application 146 displays the received static image file (step 308).

Referring now to FIG. 4, one embodiment of a protocol used by the client application 146 and the proxy server application 158 to exchange user input and application execution output is depicted diagrammatically. In the embodiment shown in FIG. 4, four protocol commands are depicted: “Get Image” 410; “Send String” 420; “Send Keystroke” 430; and “Send Mouse Event” 440.

As shown in FIG. 4, the client application 146 transmits to the proxy server application 158 an http request 412 identifying the server to which the request is directed and parameters concerning the static image requested by the client application 146. In the embodiment shown in FIG. 4, the parameters included in the http request transmitted by the client application 146 include a starting x coordinate, a starting y coordinate, an ending x coordinate, an ending y coordinate, and a preferred static image file type. The proxy server application 158 responds with an http packet 414 transmitting the requested static image file.

The protocol embodiment shown in FIG. 4 also includes three input commands, “Send String” 420, “Send Keystroke” 430, and “Send Mouse Event” 440. For each of these commands, the client application 146 transmits to the proxy server application 158 an http packet identifying the server to which the user input is directed and the input. In the case of the “Send String” command 422, the user input is a series of alphanumeric characters. In the case of the “Send Keystroke” command 432, the user input is the keystroke. In the case of the “Send Mouse Event” command 442, the user input is the x coordinate of the mouse event, the y coordinate of the mouse event, and whether the mouse event includes a “click.” In some embodiments, the “Send Mouse Event” also include an indication of which mouse button was clicked. In each of these cases, the proxy server application 158 responds to the client application 146 with an “OK” message 424, 434, 444.

Upon receipt of user input 422, 432, 442, the proxy server application 158 forwards the user input to the thin-client application 152, 154. The thin-client application 152, 154 forwards the received user input to the application server 110. the application server 110 receives the user input and provides it to the application program 122, 124, 126, 128.

The present invention may be provided as one or more computer-readable programs embodied on or in one or more articles of manufacture. The article of manufacture may be a floppy disk, a hard disk, a compact disc, a digital versatile disc, a flash memory card, a PROM, a RAM, a ROM, or a magnetic tape. In general, the computer-readable programs may be implemented in any programming language. Some examples of languages that can be used include C, C++, C#, or JAVA. The software programs may be stored on or in one or more articles of manufacture as object code.

While the invention has been shown and described with reference to specific preferred embodiments, it should be understood by those skilled in the art that various changes in form and detail may be made therein without departing from the spirit and scope of the invention as defined by the following claims.

1. A system for displaying at a user device output produced by an application program executing on a server, the system comprising:
an application server executing an application program;
a proxy server receiving from said application server data representing a screen of graphical display output produced by the application program;
a user device executing a client application, said client application receiving from said proxy server static image data representing the screen of graphical display output produced by the application program.

2. The system of claim 1 wherein said application server comprises one of a plurality of servers in a server farm.

3. The system of claim 1 wherein said proxy server receives input transmitted from said client application and transmits the received input to said application server.

4. The system of claim 1 wherein said proxy server receives data from said application server via a presentation protocol.

5. The system of claim 1 wherein said proxy server receives data from said application server via the Independent Computing Architecture (ICA) protocol.

6. The system of claim 1 wherein said proxy server receives data from said application server via the Remote Display Protocol (RDP).

7. The system of claim 1 wherein said proxy server modifies the data received from said application server.

8. The system of claim 7 wherein said proxy server scales the data received from said application server.

9. The system of claim 7 wherein said proxy server modifies the color depth of the data received from said application server.

10. The system of claim 7 wherein said proxy server performs lossy image compression on the data received from said application server.

11. The system of claim 1 wherein said proxy server receives from said application server data representing a change in a screen of graphical display output produced by the application program and transmits updated static image data to said client application.

12. The system of claim 11 wherein the updated static image data is transmitted by said proxy server after a predetermined period of time has elapsed.

13. The system of claim 1 wherein the static image data received by said client application comprises at least a portion of an image file in GIF format.

14. The system of claim 1 wherein the static image data received by said client application comprises at least a portion of an image in JPEG format.

15. The system of claim 1 wherein said client application receives static image data from said proxy server via the Hyper Text Transfer Protocol (HTTP).

16. The system of claim 1 wherein said client application comprises a JAVA application.

17. The system of claim 1 wherein said client application uses less than 50 KB of memory during execution.

18. The system of claim 1 wherein said client application requests updated static image data from said proxy server.

19. The system of claim 1 wherein said user device comprises a cell phone.

20. A method for displaying at a user device output produced by an application program executing on a server, the method comprising the steps of:
(a) executing, by an application server, an application producing a screen of graphical user interface data;
(b) transmitting to a proxy server, by the application server, the screen of produced graphical user interface data;
(c) transmitting to a user device, by the proxy server, static image data representing at least a portion of the screen of produced graphical user interface data; and
(d) displaying, by the user device, the transmitted static image data.

21. The method of claim 20 further comprising the step of formatting, by the application server, the screen of graphical user interface data produced by the executing application into at least a first message in a presentation protocol format.

22. The method of claim 20 further comprising the step of formatting, by the application server, the screen of graphical user interface data produced by the executing application into at least a first message in Independent Computing Architecture (ICA) protocol format.

23. The method of claim 20 further comprising the step of formatting, by the application server, the screen of graphical user interface data produced by the executing application into at a first message in Remote Display Protocol (RDP) format.

24. The method of claim 20 further comprising the step of creating, by the proxy server, a static image file representing at least a portion of the screen of produced graphical user interface data.

25. The method of claim 20 further comprising the step of modifying, by the proxy server, the data received from the application server.

26. The method of claim 25 wherein said modifying step comprises applying lossy image compression to the data received from the application server.

27. The method of claim 25 wherein said modifying step comprises changing the color depth of the data received from the application server.

28. The method of claim 25 wherein said modifying step comprises scaling the data received from the application server.

29. The method of claim 18 wherein step (c) comprises transmitting to a user device, by the proxy server, GIF image data representing at least a portion of the screen of graphical user output.

30. The method of claim 20 wherein step (c) comprises transmitting to a user device, by the proxy server, JPEG image data representing at least a portion of the screen of graphical user output.

31. The method of claim 20 wherein step (c) comprises transmitting to a user device via the Hyper Text Transfer Protocol (HTTP), by the proxy server, static image data representing at least a portion of the screen of produced graphical user interface data.

32. The method of claim 20 further comprising the step of receiving, by the proxy server, data representing input from the user device.

33. The method of claim 32 further comprising the step of transmitting, by the proxy server, the received user input data to the application server.

34. The method of claim 20 further comprising the step of receiving, by the proxy server, data from the application execution server representing a change in the screen of produced graphical user interface data.

35. The method of claim 34 further comprising the step of transmitting to a user device, by the proxy server, static image data representing the changed screen of produced graphical user interface data.

36. The method of claim 35 wherein said transmitting step occurs after a predetermined period of time has elapsed.

37. The method of claim 20 further comprising the step of transmitting, by the client application, a request for updated static image information.

38. An apparatus for displaying at a user device output produced by an application program executing on a server, the apparatus comprising:
a first protocol handler receiving from an application server data in a first protocol format, the data representative of a screen of graphical display output produced by an application executing on the application server; and
a second protocol handler transmitting to a client application for display static image data in a second protocol format, the static image data representative of at least a portion of the screen of graphical display output received by the first protocol handler.

39. The apparatus of claim 38 wherein the second protocol handler receives from the client application data representative of user input.

40. The apparatus of claim 39 wherein the first protocol handler transmits to the application server the data representative of user input received by the second protocol handler.

41. The apparatus of claim 38 wherein the first protocol handler translates the received data from the first protocol to the second protocol.

42. The apparatus of claim 38 wherein the second protocol handler translates the received data from the first protocol to the second protocol.

43. The apparatus of claim 38 further comprising a translation module accessing the data received by the first protocol handler in the first protocol and translating it into at least one message in the second protocol format.

44. A method for displaying at a user device graphical display output produced by an application program executing on a server, the method comprising the steps of:
(a) receiving from an application server, via a first protocol, data representative of a screen of graphical display output produced by an application executing on the application server; and
(b) transmitting to a client application for display, via a second protocol, static image data representative of at least a portion of the screen of graphical display output produced by the application executing on the application server.

45. The method of claim 44 further comprising the step of receiving from the client application, via the second protocol, data representative of user input to the application program.

46. The method of claim 45 further comprising the step of transmitting to the application server, via the first protocol, data representative of user input received from the client application.

47. The method of claim 44 further comprising the step of translating the data representative of the screen of graphical display output from the format of the first protocol to the format of the second protocol.

48. The method of claim 44 wherein step (b) comprises transmitting to a client application for display, via a second protocol, GIF data representative of at least a portion of the screen of graphical display output of the application executing on the application server.

49. The method of claim 48 wherein the GIF file is transmitted to the client application via the HyperText Transfer Protocol (HTTP).

50. The method of claim 44 wherein step (b) comprises transmitting to a client application for display, via a second protocol, JPEG data representative of at least a portion of the screen of graphical display output of the application executing on the application server.

51. A system for displaying at a user device output produced by an application program executing on a server, the system comprising:
an application server executing an application program;
a proxy server receiving from said application server data representing a screen of graphical display output produced by the application program via a presentation-level protocol;
a user device executing a client application, said client application receiving from said proxy server static image data representing the screen of graphical display output produced by the application program via HyperText Transfer Protocol (HTTP) commands.

52. A method for displaying at a user device output produced by an application program executing on a server, the method comprising the steps of:
(a) executing, by an application server, an application producing a screen of graphical user interface data;
(b) transmitting to a proxy server via a presentation-level protocol, by the application server, the screen of produced graphical user interface data;
(c) transmitting to a user device via HyperText Transfer Protocol (HTTP) commands, by the proxy server, static image data representing at least a portion of the screen of produced graphical user interface data; and
(d) displaying, by the user device, the transmitted static image data.

53. An article of manufacture having embodied thereon computer-readable program means for displaying at a user device output produced by an application program executing on a server, the article of manufacture comprising:
computer-readable program means for transmitting to a proxy server a screen of graphical user interface data produced by an application executing on the server;
computer-readable program means for communicating to a user device, by the proxy server, static image data representing at least a portion of the screen of produced graphical user interface data; and
computer-readable program means for displaying, by the user device, the transmitted static image data.

54. An article of manufacture having embodied thereon computer-readable programs means for displaying at a user device graphical display output produced by an application program executing on a server, the article of manufacture comprising:
computer-readable program means for receiving from an application server, via a first protocol, data representative of a screen of graphical display output produced by an application executing on the application server; and
computer-readable programs means for transmitting to a client application for display, via a second protocol, static image data representative of at least a portion of the screen of graphical display output produced by the application executing on the application server.
